(19) United States
(12) Patent Application Publication
(10) Pub. No.: US 2025/0350535 A1
(43) Pub. Date: Nov. 13, 2025

(54) SYSTEMS AND METHODS FOR MANAGING COMPUTER NETWORK TOPOLOGY

(71) Applicant: BCE Inc., Verdun (CA)

(72) Inventor: Navid Ghazisaidi, Montreal (CA)

(21) Appl. No.: 19/205,629

(22) Filed: May 12, 2025

Related U.S. Application Data
(60) Provisional application No. 63/646,398, filed on May 13, 2024.

(51) Int. Cl. H04L 41/12

(52) U.S. Cl. CPC H04L 41/12

(57) ABSTRACT

Systems and methods for managing a computer network topology by determining a real-time multi-state, multi-layer view of network resources are disclosed. In accordance with the present disclosure, a method for managing a computer network topology comprises: receiving a desired network topology for multiple layers of network resources within a computer network; receiving real-time state data from the network resources within the computer network; determining a network topology for each of the multiple layers of the network resources from the real-time state data;

10 comparing, for each of the multiple layers of the network resources, the determined network topology with respect to the desired network topology; and outputting a result of the comparing indicative of whether the determined network topology matches the desired network topology for each of the multiple layers of the network resources.

### CROSS-REFERENCE TO RELATED APPLICATIONS

This application claims priority to U.S. Provisional Patent Application No. 63/646,398, filed on May 13, 2024, the entire contents of which are incorporated by reference herein for all purposes.

### TECHNICAL FIELD

The present disclosure relates to managing computer network topology, and in particular to providing a real-time view of network resources within a computer network (including internet, wireless, and wireline networks).

### BACKGROUND

Existing solutions for building and managing computer network topology typically rely on a specific portion of the data collected over time from the network or manually entered to data storages (inventory databases). Such data does not necessarily reflect the exact states of network infrastructure resources (ranging from network devices (e.g. routers, switches, antennas, modems, etc.) to network cables, wires, fibers, spectrums, wavelengths, Transmission Control Protocol (TCP), User Datagram Protocol (UDP), virtual private network (VPN), multiprotocol label switching (MPLS) tunnels, etc.). Accordingly, existing solutions may result in more costly techniques to manage networks (for both troubleshooting of existing resources as well as expanding network situations).

Accordingly, systems and methods that enable a real-time accurate view of network resources within a computer network remains highly desirable.

### SUMMARY

In accordance with one aspect of the present disclosure, a method for managing a computer network topology is disclosed, comprising: receiving a desired network topology for multiple layers of network resources within a computer network; receiving real-time state data from the network resources within the computer network; determining a network topology for each of the multiple layers of the network resources from the real-time state data; comparing, for each of the multiple layers of the network resources, the determined network topology with respect to the desired network topology; and outputting a result of the comparing indicative of whether the determined network topology matches the desired network topology for each of the multiple layers of the network resources.

In some aspects, the method further comprises generating a notification for performing troubleshooting when the determined network topology is different than the desired network topology.

In some aspects, the multiple layers of the network resources comprise two or more of: a physical layer, a logical layer, and a service layer.

In some aspects, the determined network topology comprises one or both of discovered topology and operational topology.

In some aspects, the real-time state data for determining the discovered topology is acquired using streaming protocols supported by one or more of the network resources.

In some aspects, the method further comprises normalizing the real-time state data for use in determining the discovered topology.

In some aspects, the real-time state data for determining the operational topology is acquired by running commands on one or more of the network resources and receiving the real-time state data as output.

In some aspects, the real-time state data for a given network resource is one of: installed, ready to be installed, provisioned, ready to be provisioned, carrying traffic, idle, overloaded, and underloaded.

In some aspects, the computer network is a wireline or wireless network.

In accordance with one aspect of the present disclosure, a non-transitory computer-readable memory having computer-executable instructions stored thereon is disclosed which, when executed by a processor, configure the processor to perform the method of any one of the above aspects.

In accordance with one aspect of the present disclosure, a system for managing a computer network topology is disclosed, comprising: a processor; and a non-transitory computer-readable memory having computer-executable instructions stored thereon which, when executed by the processor, configure the system to perform a method comprising: receiving a desired network topology for multiple layers of network resources within a computer network; receiving real-time state data from the network resources within the computer network; determining a network topology for each of the multiple layers of the network resources from the real-time state data; comparing, for each of the multiple layers of the network resources, the determined network topology with respect to the desired network topology; and outputting a result of the comparing indicative of whether the determined network topology matches the desired network topology for each of the multiple layers of the network resources.

In some aspects, the system comprises a topology manager configured to build the network topology from the real-time state data.

In some aspects, the topology manager is configured to build the network topology using one or both of discovered topology and operational topology.

In some aspects, the system further comprises a plurality of adapters configured to receive the real-time state data from the network resources within the computer network using streaming protocols supported by one or more of the network resources.

In some aspects, the system further comprises a data normalizer configured to normalize the real-time state data for use in determining the discovered topology.

In some aspects, the system further comprises a plurality of command parser adapters configured to run commands on one or more network resources and receive the real-time state data as output for providing to the topology manager for determining the operational topology.

In some aspects, the system is further configured to generate a notification for performing troubleshooting when the determined network topology is different than the desired network topology.

In some aspects, the multiple layers of the network resources comprise two or more of: a physical layer, a logical layer, and a service layer.

In some aspects, the real-time state data for a given network resource is one of: installed, ready to be installed, provisioned, ready to be provisioned, carrying traffic, idle, overloaded, and underloaded.

In some aspects, the computer network is a wireline or wireless network.

### BRIEF DESCRIPTION OF THE DRAWINGS

Further features and advantages of the present disclosure will become apparent from the following detailed description, taken in combination with the appended drawings, in which:

FIG. 1A shows a representation of a system for managing a computer network topology;

FIG. 1B shows a representation of an example computer network topology;

FIG. 2 shows a method for managing a computer network topology;

FIG. 3 shows a schematic representation for managing a computer network topology;

FIG. 4 shows a schematic representation of collecting real-time state data from the network resources within the computer network;

FIG. 5 shows a schematic representation of determining a discovered topology of the network resources within the computer network; and

FIG. 6 shows a schematic representation of determining an operational topology of the network resources within the computer network.

It will be noted that throughout the appended drawings, like features are identified by like reference numerals.

### DETAILED DESCRIPTION

The present disclosure provides systems and methods for managing computer network topology. The systems and methods in accordance with the present disclosure provide a real-time and accurate multi-state, multi-layer view of network resources within a computer/telecom network, which can be used in a variety of downstream applications and enables operators to do fast, reliable, and cost- efficient fault management/troubleshooting, as well as build more advanced intelligent techniques to manage network resources (such as AI/ML-driven congestion avoidance and capacity management based on data streamed and collected from network (as the source of truth) and being validated against the intentional designs). Having an accurate real-time view of network resources helps operators to reduce the outage times (more availability) and eventually avoiding outages (especially by means of machine learning and artificial intelligence (ML/AI) techniques). Moreover, historical topology data plus network resource utilizations (performance metrics) can be used by Al/ML to identify traffic patterns and predict/forecast future service flow needs. This will result in a better (more accurate) capacity/resource planning (e.g., which area of network infrastructure (in different layers (i.e., physical or logical)) needs to be expanded or decommissioned). The systems and methods disclosed herein are applicable to both wireline (optical fiber, copper, etc.) and wireless (Wi-Fi, cellular (4G/5G), etc.) networks.

In accordance with at least some aspects of the present disclosure, a method of managing a computer network topology comprises receiving a desired network topology for multiple layers of network resources within a computer network; receiving real-time state data from the network resources within the computer network; and determining a network topology for each of the multiple layers of the network resources from the real-time state data. The determined network topology may comprise one or both of discovered topology and operational topology.

Advantageously, the systems and methods disclosed herein for determining the network topology perform data collection and normalization such that the topology manager application used for building/determining the network topology is vendor-agnostic. That is, instead of requiring the topology manager application to integrate different vendor solutions respectively, the real-time state data is collected and normalized in a data mediation layer that then passes the processed state data from the network resources to the topology manager. A result is that the topology manager is more lightweight and the system design is more efficient, as any changes in network resource data schemas can be accounted for by the mediation layer and does not require a reconfiguration of the topology manager.

For each of the multiple layers of the network resources, the determined network topology is compared with respect to the desired network topology. A result of the comparison is output that is indicative of whether the determined network topology matches the desired network topology for each of the multiple layers of the network resources. Accordingly, when the determined network topology matches the desired network topology, the real-time state data can be used for managing the network resources within the computer network. When the determined network topology is different than the desired network topology, a notification can be generated for performing troubleshooting.

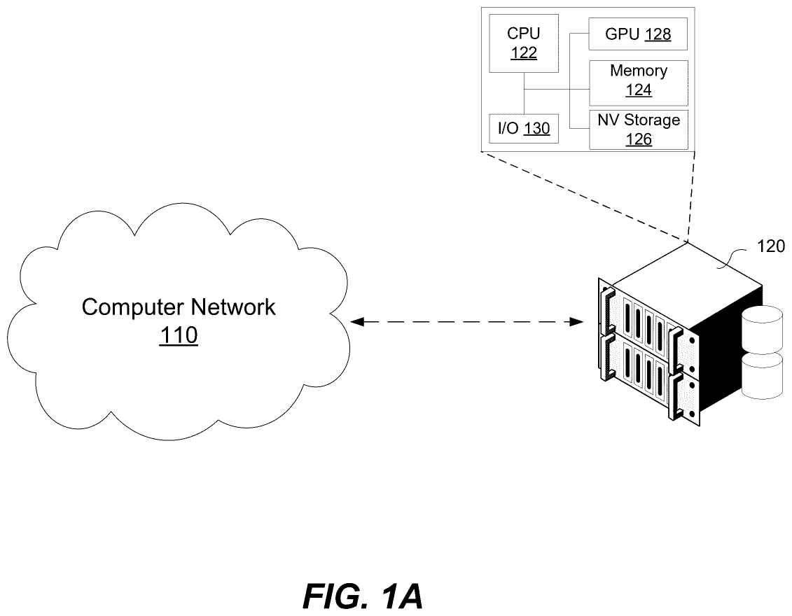

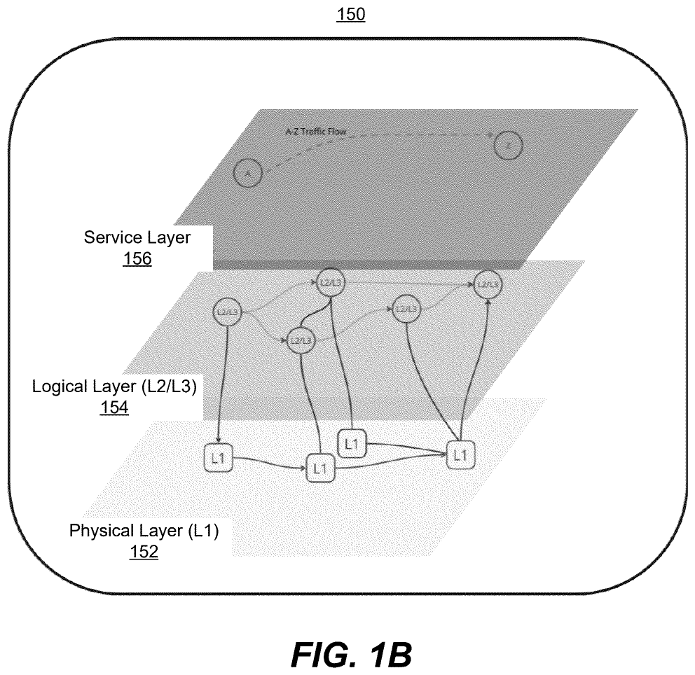

Embodiments are described below, by way of example only, with reference to FIGS. 1A-6.

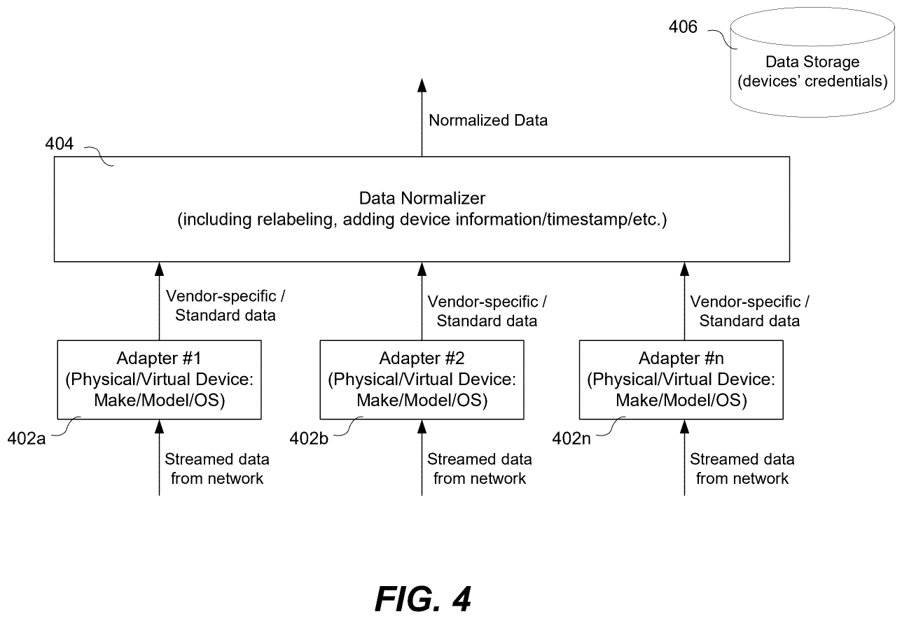

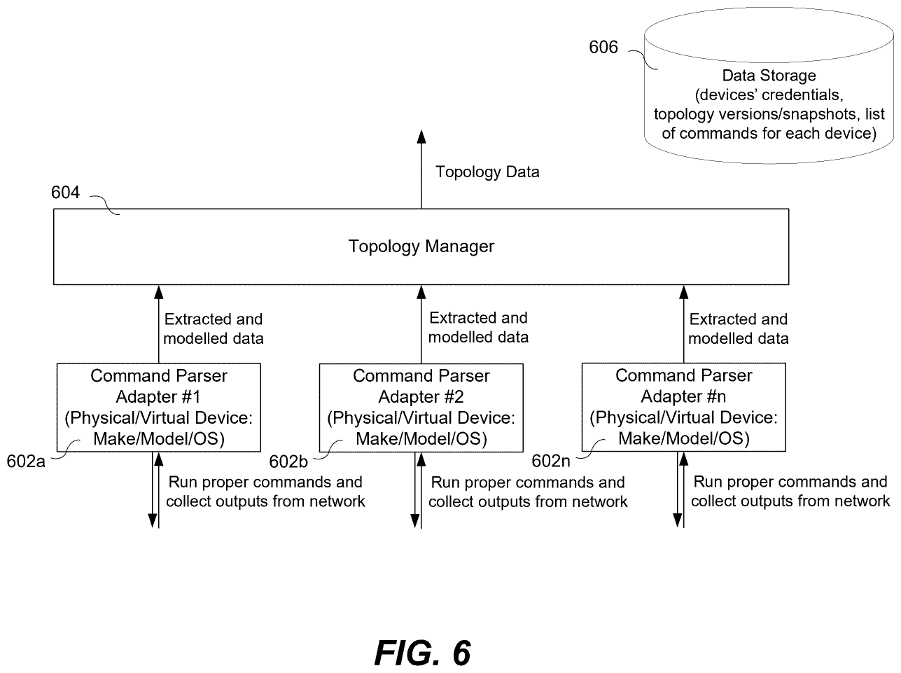

FIG. 1A shows a representation of a system for managing a computer network topology. The system comprises a central server 120 (or multiple servers 120) that is configured to communicate with network resources (e.g. via adapters located in the server(s) and appropriate APIs, as described in more detail below with reference to FIGS. 4 and 6) and manage an integrated, multi-layer computer network topology for multiple layers of network resources within a computer network 110. The network resources comprise various devices, cables, etc., which may be provided by numerous vendors, and the computer network 110 may be a wired or wireless network. The multiple layers of the multi-layer computer network topology may comprise a physical layer (i.e. how the network resources are physically connected), a logical layer (i.e. how the network resources are logically connected), and a service layer (i.e. how the network resources service customers). A typical computer network has several layers per OSI (Open Systems Interconnection model), namely: L1: physical layer; L2-L3: logical layers; and L4-L7: service layers.

FIG. 1B shows a representation of an example computer network topology 150, comprising a physical layer (L1) 152, a logical layer (L2/L3) 154, and a service layer 156. Network resources in the physical layer 152 are physical devices that are physically connected as represented by solid lines. Network resources in the logical layer 154 are physical devices that are logically connected as represented by the lighter lines in the logical layer 154, and that are physically connected through the physical layer devices as represented by the darker solid lines. As depicted in the service layer 156, an example of traffic flow from A-Z is represented using dashed lines. In this case, network resources from the physical layer 152 and the logical layer 154 are in the path and the network resources from the physical and logical layers carry the traffic from A-Z.

As described above, it is desirable to have visibility into how devices are connected across different layers, and to know the real-time states of these devices. The central server 120 may be operated by a telecommunications service provider. A real-time and accurate view of network resources within the computer network 110 enables automated and intelligent (i.e. machine learning/artificial intelligence) decision-making by the service provider to provision network resources, learn resource consumption, make predictions for capacity management, etc. The central server 120 may provide a platform accessible by network operators/users and present a user interface that allows such network operators/users to visualize and manage computer network topology, as described herein.

The central server 120 comprises a processor, e.g. CPU 122, and a non-transitory computer-readable memory 124 that are communicatively coupled to each other. The non-transitory computer-readable memory 124 has stored on it computer-executable program code at runtime to cause the central server 120 to perform a method of managing a computer network topology, as described in more detail herein. The central server 120 further comprises non-volatile storage 126 having stored thereon program code that are loaded into the non-transitory computer-readable memory 124 at runtime. The central server 120 may comprise graphical processing units (GPU 128) that controls a display and may be used to run the machine learning and/or AI algorithms. The central server 120 also comprises an input/output (I/O) interface 130 for communicating with one or more external devices, including network resources on the computer network 110.

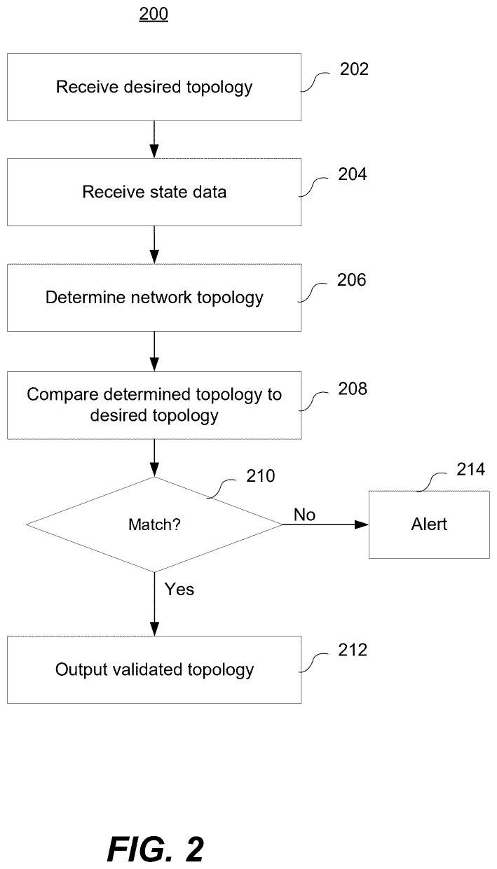

FIG. 2 shows a method 200 for managing a computer network topology. The method 200 may be implemented by the central server(s) 120 of FIG. 1, such as upon execution of computer-readable instructions stored in non-transitory computer-readable memory 124, for managing an integrated, multi-layer computer network topology for multiple layers of network resources within a computer network.

The method 200 comprises receiving a desired network topology for multiple layers of network resources within a computer/telecom network (202). The multiple layers of the network resources may comprise two or more of: a physical layer, a logical layer, and a service layer. The computer network may be a wireline or a wireless network. The desired network topology may be received offline or online.

Real-time state data is received from the network resources within the computer network (204). For example, the real-time state data for a given network resource may be one of: installed, ready to be installed, provisioned, ready to be provisioned, carrying traffic, idle, overloaded, and underloaded.

A network topology is determined for each of the multiple layers of the network resources from the real-time state data (206). As discussed in more detail below, the determined network topology may comprise one or both of discovered topology and operational topology.

The determined network topology is compared with respect to the desired network topology for each of the multiple layers of the network resources (208). As described in more detail below, a topology data model schema is defined that facilitates comparing the determined network topology and the desired network topology, in particular by comparing a status of a given network resource and links between network resources in the determined network topology against the desired network topology. Comparing the determined network topology with the desired network topology allows for validating the real-time state of the network resources for each layer. A determination is made as to whether the determined network topology matches the desired topology for each of the multiple layers of the network resources (210). When the determined network topology matches the desired network topology (YES at 210), an output is generated indicative that the topology is validated (212). When the determined network topology does not match the desired network topology (NO at 210), an alert or notification can be generated for performing troubleshooting (214).

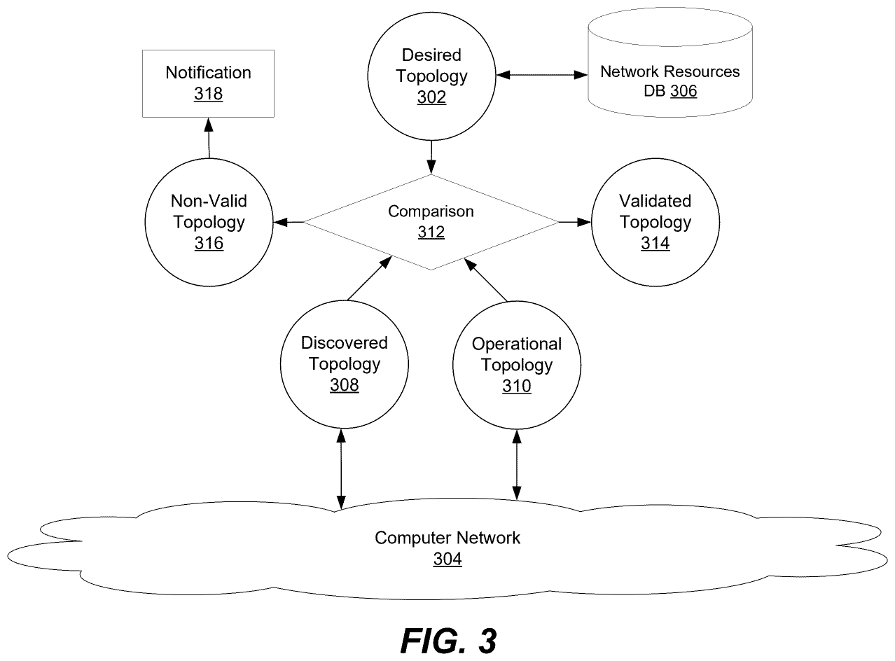

FIG. 3 shows a schematic representation for managing a computer network topology, which is based on the method 200. The operations shown in FIG. 3 may be implemented by the central server(s) 120 of FIG. 1, which is configured to manage an integrated, multi-layer computer network topology for multiple layers of network resources within a computer network, such as a telecommunications network.

A desired computer network topology 302 is prepared for multiple layers of network resources within a computer network 304. The computer network 304 comprises network resources including network elements/devices and wires/cables/fibers/spectrums as well as logical connectivities used for connecting the network devices with each other.

The desired computer network topology 302 may be prepared based on information stored in a network resources database 306, which may store information on the network resources in the computer network 304. The desired computer network topology 302 may be prepared by a human or by an AI algorithm. The desired computer network topology 302 may be prepared in real-time (i.e. online) or ahead of time (i.e. offline). The desired computer topology includes multiple layers of topologies, such as topologies for physical (e.g. cabling, etc.), logical (e.g. packet, IP, Ethernet, etc.), and service (e.g. VPN, etc.) layers.

Current topologies of the network resources within the computer network 304 are determined by determining real-time state data of the network resources. Network resource states may for example include: installed, ready to be installed, provisioned, ready to be provisioned, carrying traffic, idle, overloaded, underloaded, etc. The current topology is determined for each layer of the network topology from the real-time state data. There are two ways in which topology data may be determined, namely, discovered topology 308 and operational topology 310.

Discovered topology 308 (may also be referred to as learned topology) may be protocol-based and obtained based on streamed data collected from the computer network 304. Technologies such as gRPC (Google Remote Procedure Call), gNMI (Google Network Management Interface), BMP (BGP (Border Gateway Protocol) Monitoring Protocol), LLDP (Logical Link Discovery Protocol), IPFIX (Internet Protocol Flow Information Export), CDP (Cisco Discovery Protocol), NetFlow, etc., may be used for obtaining the discovered topology 308. The collected data may also be pre-processed (e.g. normalized) to obtain the discovered topology 308. The real-time state data used for determining the discovered topology 308 may be obtained on-demand, at predetermined frequencies, or event-driven. That is, the discovered topology may be captured at predetermined times (e.g. every few minutes/hours/days/etc.) or event-based (e.g. as soon as a network event happens (which means any change in network is identified). Accordingly, the discovered topology 308 can be built on-demand per query.

Operational topology 310 (may also be referred to as running state topology) may be obtained based on the running configuration database of network devices by running certain commands on the devices and reading the outputs from network internal database, and may thus be different from the discovered (protocol-based) topology. Further, only operational topology may be obtainable for legacy devices, e.g. where a network resource does not support the required protocols for discovered topology. The protocols used to collect the running configuration information from the network resources may include CLI (Command Line Interface), TL1 (Transaction Language 1), EMS (Element Management System), SNMP (Simple Network Management Protocol), NMS (Network Management System), etc. The operational topology 310 may be built based on inquiries, at pre-determined frequencies, or event-driven.

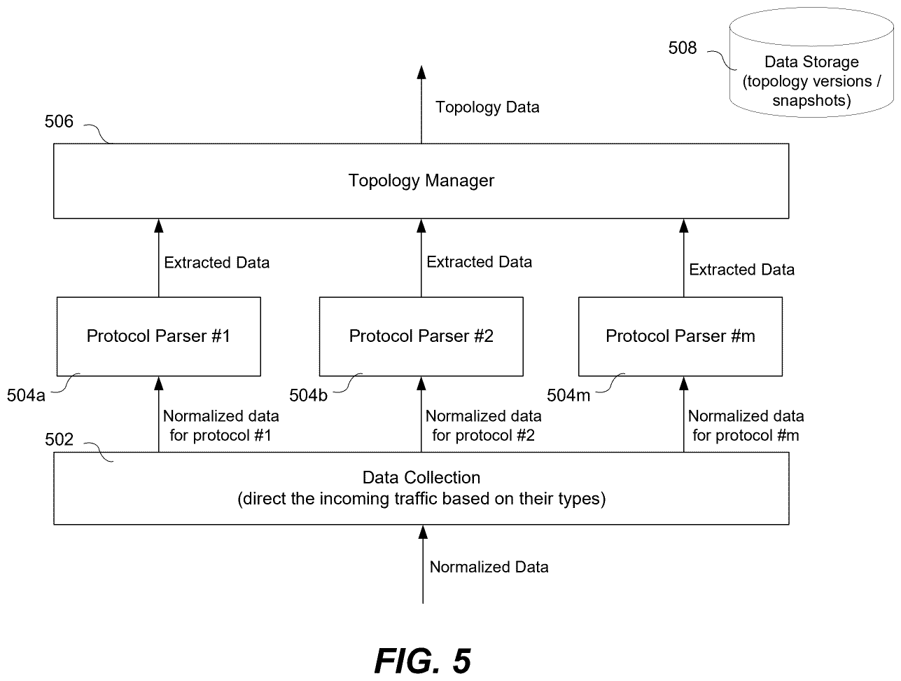

A particular advantage provided by the systems and methods in accordance with the present disclosure is that the discovered topology 308 and/or operational topology 310 are vendor-agnostic and thus provide a complete view of network resources within a computer network. It will be appreciated that the network resources within the computer network 304 are typically provided by various vendors. While some existing technologies are able to provide information for vendor-specific devices, such information would only represent a part of the computer network 304 and would thus be incomplete. In order to build and manage a computer network topology for all network resources within the computer network 304, data from all network resources should be obtained and aggregated. FIGS. 4 thru 6 further show how data is collected and used to build discovered and operational topologies for the network resources. In particular, FIG. 5 shows how the discovered topology is built using streaming telemetry and network protocols supported by some devices. FIG. 6 shows how the operational topology is built using commands (like those listed above) running on the devices. For operational topology (as described with reference to FIG. 6), adapters understand which commands need to be run for each network device, while for discovered topology (as described with reference to FIG. 5), the stream data is normalized by a “data normalizer” shown in FIG. 4.

FIG. 4 shows a schematic representation of collecting real-time state data from the network resources within the computer network for determining a discovered topology, which is vendor agnostic.

Network data (including topology data, performance metrics (PMs), telemetry, and events/alarms) is streamed or pushed by (physical or virtual) network elements to adapters 402a, 402b, . . . 402n. The adapters 402a, 402b, . . . 402n are responsible to maintain the connectivity and upon receiving the network data parses it, understands the format, and hands the data off to data normalizer 404. The format of the network data varies from one vendor to another one (even in the same domain/layer). An example of network/state data may for example have the following data schema:

```
notification: <
  timestamp: 1565671919030747121
  update: <
    path: <
      elem: <
        name: ″srl_nokia-interfaces:interface″
        key: <
          key: ″name″
          value: ″mgmt0″
        >
      >
    >
    val: <
      json_ietf_val: ″{
              ″name″: “mgmt0″,
              ″subinterface″:[ {
                    ″index″: 0,
                    ″admin-state″: ″enable″,
                ″ip-mtu″: 1500,
                    ″ifindex″: 524288000,
                  “operstate″: ″up″,
                    ″last-change″: ″2019-08-11T17:21:48.366Z″,
                      ...
            ″statistics″: {
                ″in-pkts″: ″5136″,
                    ″in-octets″: ″438953″,
                ″in-error-pkts″: ″0″,
                    ″in-discarded-pkts″: ″0″,
                ″in-terminated-pkts″: ″5136″,
                    ″in-terminated-octets″: ″438953″,
                    ″in-forwarded-pkts″: ″0″,
                    ″inforwarded-octets″: ″0″,
                    ″out-forwarded-pkts″: ″6062″,
                    ″out-forwarded-octets″: ″2746613″,
                ″out-error-pkts″: ″0″,
                  ″out-discarded-pkts″: ″0″,
                ″out-pkts″: ″6062″,
                  ″out-octets″: ″2746520″
        },
              ″srl_nokia-qos:qos″: {
                  ″input″: {
                      ″classifiers″: {
                          ″ipv4-dscp″: ″default″,
                        ″ipv6-dscp″: ″default″,
                          ″mpls-tc″: ″default″
                }
              }
      } ]
    >
  >
>
```

It is very complex to build a network topology of network elements that provide data in different data formats. There is even more complexity when considering vendors in different domains/layers. Accordingly, in accordance with the present disclosure the network data is normalized. The data normalizer 404 unifies/normalizes the data to a pre-specified vendor-agnostic data format (aka schema) and publishes that data to a Discovered Topology application. The process of defining normalized generally starts from looking at data in the respective network layers/domains, which are defined based on the available standards in that area. Specific standards for each domain/layer may be used (like openconfig for IP, TAPI for optical, BBF for access, 3gpp for wireless, etc.) and the general common data may be extracted to develop a normalized data schema. It is important to understand vendors' data models to ensure correct mapping of data from the vendor data schema to the normalized data schema.

An example of normalized data schema for data collected from devices may for example be:

```
{
  ″version″: ″<schema-version>″,
  “timestamp″: ″<time-stamp>″,
  ″data-source″: ″<device-name>″,
  ″data-type″: ″<model#>″,
  ″uuid″: ″<uuid>″
  ″payload″: {
    ″version″: ″<model-version>″,
    ″model#″: {
      ...
    },
  }
}
```

The model# shown above indicates the data model format should be used for that specific data. For example, standard data models, e.g., openconfig, TAPI, etc. may be used depending on the network layer/domain. For instance, the openconfig-interfaces schema is provided below, and the openconfig-interfaces schema can be used to replace model# in the above normalized data schema.

```
″openconfig-interfaces″: {
  ″interfaces″: {
    ″interface″: [{
      ″name″: ″<interface-name>″,
      ″state″: {
        ″type″: ″<interface-type (e.g. IF_ETHERNET)>″,
        ″admin-status″: ″<UP/DOWN>″,
        ″oper-status″: ″<UP/DOWN>″,
        ″description″: ″<description>”,
        ″counters″: {
          ″in-octets″: ″<bytes-received>″,
          ″in-pkts″: ″<packets-received>″,
          ″in-errors″: ″<number-of-errors-packets>″,
          ″in-discards″: ″<number-of-dropped-packets>″,
          ″out-octets″: ″<bytes-sent>″,
          ″out-pkts″: ″<packets-sent>″,
          ″out-errors″: ″<number-of-errors-packets>″,
          ″out-discards″: ″<output-of-dropped-packets>″,
          ″carrier-transitions″: ″<number-of-up-down-since-last-restart>”
            },
      },
    }],
  }
}
```

The normalized data can also be stored in a data storage 406. The process performed in FIG. 4 may be performed in real-time based on data collected from the network devices.

FIG. 5 shows a schematic representation of determining a discovered topology of the network resources within the computer network.

The normalized data is published and received by a data collection module 502. A data classifier within data collection module 502 separates the incoming data based on their data models/protocols (as the system understands the meaning of data fields for different data models/protocols) and hands off normalized data for respective protocols off to protocol parsers 504a, 504b, . . . 504m, which parse the data to compile the collected normalized/standardized/cleaned-up protocol data. The output of extracted data coming from protocol parsers 504a, 504b, . . . 504m is provided to topology manager 506, which builds the discovered topology from the data fields in the extracted data. Topology manager 506 then publishes the topology data in its specified format, and discovered topology versions/snapshots can be stored in a data storage 508.

FIG. 6 shows a schematic representation of determining an operational topology of the network resources within the computer network.

Command parser adapters 602a, 602b, . . . 602n initiate and maintain the connectivity to each (physical or virtual) network element/resource. The command parser adapters 602a, 602b, . . . 602n run certain commands on the network element/resources and receive the outputs of them. Each network element/resource has an internal data storage which includes the running configurations of that network element. The commands obtain a copy of those running configurations. An example of a running configuration output is as follows:

Router#show running-configuration filter vrf vrf80
|| Building configuration...
|| IOS XR Configuration 24.2.11.32M
|| Last configuration change at Mon Jan 15 05:09:20 2024
|
vrf vrf80
address-family ipv4 unicast
import route-target
1:80
|
export route-target
1:80
|
|
address-family ipv6 unicast
import route-target
1:80
|
export route-target
1:80
|
|
|
neighbor 192.0.2.1
remote-as 200
ebgp-multihop 4
update-source Loopback90
address-family ipv4 unicast
route-policy PASS in
route-policy PASS out
|
|
|
|
end

The command parser adapters 602a, 602b, . . . 602n use the output of collected commands and models them in a pre-specified format which is understandable by a topology manager 604. Similar to discovered topology manager 506, the operational topology manager 604 connects the dots in the extracted and modelled data to build the operational topology in a desired topology data model schema and publishes the operational topology data in its specified format. The operational topology versions/snapshots, as well as device information and a list of commands for each device, can be stored in a data storage 606.

Referring back to FIG. 3, a comparison 312 is performed between each layer of the desired topology 302 and the discovered topology 308 and/or operational topology 310 to determine a differential or delta between the desired topology of the network resources and the real-time states of the network resources. It is preferable that the desired topology 302 is compared against both the discovered topology 308 and the operational topology 310. However, if one of the discovered or operational topologies are not available (e.g. if discovered topology is not available for legacy devices that do not support the streaming protocols), the comparison 312 may be performed against only the available topology. An example of topology data model schema that can be used for building the discovered/operational topologies and for comparison against desired/intended topology as well as for any downstream AI/ML use cases, etc., may be:

```
{
  ″version″: ″<schema-version>″,
  ″timestamp″: ″<time-stamp>″,
  device :{
    ″device-id″: ″<device-id>″,
    ″device-name″: ″<device-name>″,
    ″device-make″: <vendor-name>″,
    ″os″: “<os-version>″,
    ″device-type″: ″<type>″,
    ″device-address″: ″<mac address of device>″,
    ″interface″: {
      ″interface-name″: ″<name of the interface>″
      ″status″ : ″<UP/DOWN>″
      ″mac-address″: ″<mac address>″,
      ″encapsulation-type″: <encapsulation>″,
      ″lag-member″: ″<TRUE/FALSE>″,
      ″lag-info: : {
      ″lag-group″: ″<LAG group>″,
      ″member-link″: ″<LAG member id>″
    },
  },
  link: {
    ″source-id″: ″<device id of the source>″,
    ″destination-id″: ″<device id of the destination>″
    ″status″ : ″<UP/DOWN>″
    ″link″: {
      ″source-interface-name″: ″<name of the source interface>″,
      ″destination-interface-name″: ″<name of the destination interface>″
      ″rate″: ″<speed of the link>″,
      ″duplex″: ″<FULL/HALF>″
    },
  }
}
```

The topology data, such as the example schema above, is defined based on requirements for the network to show the topology, and which can be used to provide a fair and meaningful comparison between the desired topology and determined topology. It will be appreciated that alternative topology data model schemas may be defined, provided that the data model schema includes device states and links fields and allows for a graphical representation of the topology (i.e. showing node/edge combinations). Based on the comparison, the topology of each layer is considered to be validated topology 314 or non-valid topology 316. Validated topology 314 is a topology layer where the real-time states of network resources match the desired topology 302. Validated topology 314 can be used for network provisioning. Non-valid topology 316 is a topology layer where the real-time states of network resources do not match the desired topology 302. Non-valid topology 316 should not be used and the network resources may be isolated. A notification 318 may be generated for non-valid topology 316 to trigger troubleshooting and/or further analysis to understand why a network resource(s) does not match with the desired topology 302. One example of a reason for non-valid topology 316 may be due to miscabling or misconfiguring the network resources in the field. One action to address the not verified/validated network resource status in non-valid topology 316 may be simply updating the desired topology 302 as long as it meets the network design requirements.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

1. A method for managing a computer network topology, comprising:
receiving a desired network topology for multiple layers of network resources within a computer network;
receiving real-time state data from the network resources within the computer network;
determining a network topology for each of the multiple layers of the network resources from the real-time state data;
comparing, for each of the multiple layers of the network resources, the determined network topology with respect to the desired network topology; and
outputting a result of the comparing indicative of whether the determined network topology matches the desired network topology for each of the multiple layers of the network resources.

2. The method of claim 1, further comprising generating a notification for performing troubleshooting when the determined network topology is different than the desired network topology.

3. The method of claim 1, wherein the multiple layers of the network resources comprise two or more of: a physical layer, a logical layer, and a service layer.

4. The method of claim 1, wherein the determined network topology comprises one or both of discovered topology and operational topology.

5. The method of claim 4, wherein the real-time state data for determining the discovered topology is acquired using streaming protocols supported by one or more of the network resources.

6. The method of claim 5, further comprising normalizing the real-time state data for use in determining the discovered topology.

7. The method of claim 4, wherein the real-time state data for determining the operational topology is acquired by running commands on one or more of the network resources and receiving the real-time state data as output.

8. The method of claim 1, wherein the real-time state data for a given network resource is one of: installed, ready to be installed, provisioned, ready to be provisioned, carrying traffic, idle, overloaded, and underloaded.

9. The method of claim 1, wherein the computer network is a wireline or wireless network.

10. A non-transitory computer-readable memory having computer-executable instructions stored thereon which, when executed by a processor, configure the processor to perform the method of claim 1.

11. A system for managing a computer network topology, comprising:
a processor; and
a non-transitory computer-readable memory having computer-executable instructions stored thereon which, when executed by the processor, configure the system to perform a method comprising:
receiving a desired network topology for multiple layers of network resources within a computer network;
receiving real-time state data from the network resources within the computer network;
determining a network topology for each of the multiple layers of the network resources from the real-time state data;
comparing, for each of the multiple layers of the network resources, the determined network topology with respect to the desired network topology; and
outputting a result of the comparing indicative of whether the determined network topology matches the desired network topology for each of the multiple layers of the network resources.

12. The system of claim 11, comprising a topology manager configured to build the network topology from the real-time state data.

13. The system of claim 12, wherein the topology manager is configured to build the network topology using one or both of discovered topology and operational topology.

14. The system of claim 13, further comprising a plurality of adapters configured to receive the real-time state data from the network resources within the computer network using streaming protocols supported by one or more of the network resources.

15. The system of claim 14, further comprising a data normalizer configured to normalize the real-time state data for use in determining the discovered topology.

16. The system of claim 13, further comprising a plurality of command parser adapters configured to run commands on one or more network resources and receive the real-time state data as output for providing to the topology manager for determining the operational topology.

17. The system of claim 11, wherein the system is further configured to generate a notification for performing troubleshooting when the determined network topology is different than the desired network topology.

18. The system of claim 11, wherein the multiple layers of the network resources comprise two or more of: a physical layer, a logical layer, and a service layer.

19. The system of claim 11, wherein the real-time state data for a given network resource is one of: installed, ready to be installed, provisioned, ready to be provisioned, carrying traffic, idle, overloaded, and underloaded.

20. The system of claim 11, wherein the computer network is a wireline or wireless network.
